(19) United States
(12) Patent Application Publication
(10) Pub. No.: US 2004/0215500 A1
(43) Pub. Date: Oct. 28, 2004

(54) Rapid response marketing

(76) Inventor: Brian F. Monahan, Mill Valley, CA (US)

Correspondence Address: Thomas J. Monahan, 40 Bennett's Ridge Road, Sandy Hook, CT, 06482, US

(21) Appl. No.: 09/808,490

(22) Filed: Mar. 14, 2001

(51) Int. Cl. G06F 17/60

(52) U.S. Cl. 705/10; 705/1

(57) ABSTRACT

A system and method for managing marketing communications. The invention provides a system for rapid response marketing which is based upon performance of marketing communications. The system provides a rapid, data driven and highly efficient marketing capability for an individual advertiser.

### TECHNICAL FIELD

This invention relates to customized continuously interactive marketing systems and methods which are performance based and create a rapid, data-driven, efficient marketing capability for an individual advertiser.

### BACKGROUND OF THE INVENTION

By way of background, technology is increasingly allowing marketers to measure the results of their marketing investment. The efficacy of a marketing investment takes on heightened importance in the networked marketplace of the Internet where every competitive seller is one click away. Marketers that are quickly able to read the results of a marketing campaign and react accordingly, stand the best chance of gaining market share.

In order to understand what marketing investments work, marketers must integrate varied data sources. These sources may include, but are not limited to, media contracts, media delivery information, call center volume, store foot traffic, sales scanner data, focus group responses, and web site traffic.

Typically, the management of varied marketing functions are outsourced to specialists such as advertising agencies, public relationship agencies, eCRM consultants and the like who have the tools and the specialized experience to perform niche tasks. However, a unified ongoing picture of all marketing communications activity with performance-based assessment and reaction capability is not provided. The benefit of continuously evaluating all marketing investments on an objective basis in view of a requirement of actual sales or other ultimate business objective or goal of the marketer, suggests that marketers establish an in-house integrated continuously interactive marketing management capability.

A growing number of both traditional, as well as dot.com commercial enterprises, utilize the Internet for business activities involving the provision of goods and services. The success or failure of such businesses is often related to their marketing systems. Technical advances have dramatically altered traditional marketing and transformed marketing into an exciting new discipline. Marketing often moves with the speed of electromagnetic transmissions. The integration of the various contemporary marketing communications parameters into an efficient and productive system specifically adapted to rapidly monitor and assess the achievement of marketing goals on an ongoing basis with a reaction capability is highly desirable.

The World Wide Web, which is not yet a decade old, serves as the vehicle which permits or supplements the operation of traditional businesses as well as a growing number of web-based businesses. Conventional business methodologies and practices are quite different in structure and function from those utilized and under development by internet businesses. For example, many web-based businesses can be regarded as stores with centralized service, information, sales, customer relations and other functions. Some costs to internet businesses, i.e., advertising, have proven, at least to date, to be considerably more expensive than those charged for other traditional media by advertising agencies. Accordingly, effective integration of the various functions that constitute a marketing system which can be modified and adapted to both internet and traditional businesses is highly desirable. Implementation of integrated marketing systems will markedly influence the success or failure of businesses.

Therefore, an object of this invention is to provide a means for the integration of various marketing functions for businesses that will benefit from rapid application of marketing performance data. Another object of this invention is to provide integrated marketing systems that are specifically adapted to the needs of the particular user. Yet another object of this invention is to provide a system and method for assessing, selecting, developing, and implementing a fully-integrated individualized marketing system for a particular user. These and other objects of the invention are achieved by the present disclosure of systems and methods relating to integrated marketing systems.

### SUMMARY OF THE INVENTION

The present invention provides a system and methods for the construction and use of interactive marketing programs useful for commercial business activities where success is predicated in significant part upon the ability to rapidly and efficiently effect interactive marketing thereby managing relationships with customers. The interactive marketing needs and capabilities of individual businesses vary considerably. The present invention enables the integration of variable strategic business objectives and technical capabilities with marketing tools and practices to effect desirable interactive marketing systems. The success or failure of implemented interactive marketing systems can thereafter be evaluated.

Varied information is first gathered from the particular user. Such information includes, for example, the identification of user marketing objectives, technical and personnel capabilities, historical marketing efforts, monetary constraints, time or other implementation parameters and other selected variables. Information obtained from the user is assessed in view of the user=s strategic business objectives, including evaluation involving various interactive marketing tools, materials and methods comprising customer acquisition, customer retention, branding and intellectual property, conversion, insight, public relations, recruitment, and international components. Following the obtainment of information data, assessment and evaluation, systems recommendations are determined and provided to the user for implementation. The implemented systems may optionally be monitored and their effectiveness determined.

### DETAILED DESCRIPTION OF THE INVENTION

The present invention provides businesses, including e-businesses, with a means of managing customer relationships by rapidly and efficiently designing customized interactive marketing systems. The ability of businesses to effect interactive marketing systems that suit their individual requirements and have adaptive ability to accommodate market conditions that rapidly change will often determine the success or failure of a particular business. Thus, the invention produces user-specific interactive marketing systems that accommodate and accomplish marketing objectives of the user.

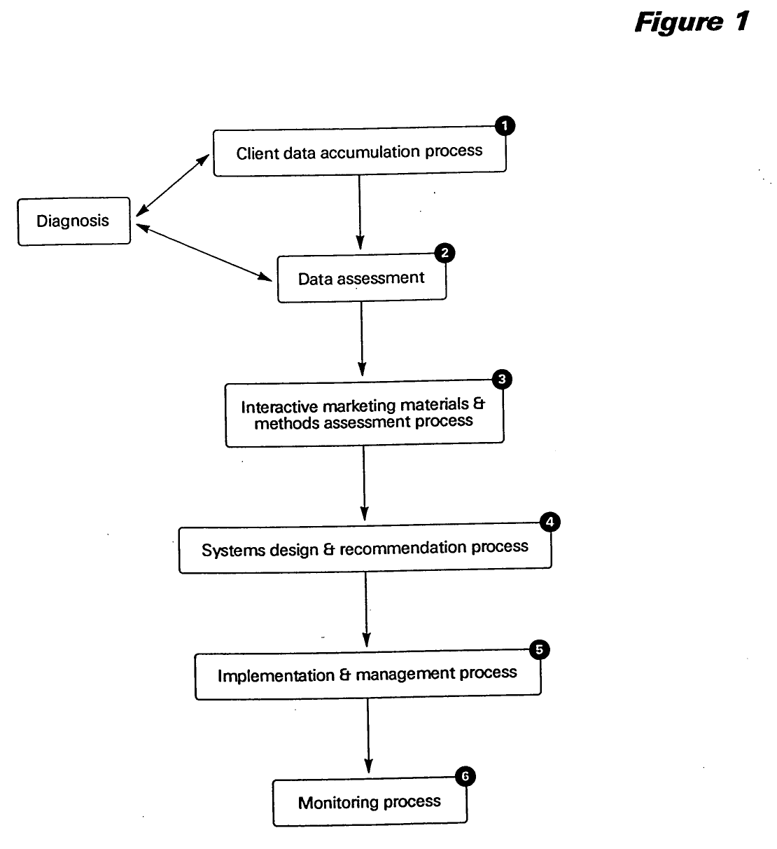

In a process of the invention, the initial step involves diagnosis which includes client or user data accumulation (FIG. 1, Step 1) and data assessment (FIG. 1, Step 2). The client should identify its quantifiable objectives designated to accomplish its strategic business goals. Such objectives include, but are not limited to, such considerations as customers, revenue, expenses, profit, costs per customer, etc. In support of interactive marketing system development, implementation and maintenance, it is preferred that a centralized database, utilizing either commercially available or customized software, be maintained. Multiple databases may also be used. Technical and personnel capabilities are identified, including but not limited to database architecture to support granular tracking of marketing efforts, staff capability to facilitate implementation of customized tracking, data queries, etc. Historical marketing efforts of the client, if available, should be identified, including but not limited to magazine, newspaper, radio, television, web site utilization, or other advertisements. Existing marketing staff capabilities, including experience of personnel, hiring plans etc. should be determined. Following client data accumulation, it is assessed and the marketing challenges, including strengths and weaknesses, of the client are delineated (FIG. 1, Step 3). The diagnosis step enables the overall extent or scope of work that is required for the client=s customized interactive marketing system.

The design of interactive marketing systems for business enterprises, including e-businesses, involves the identification and evaluation of, or research of various contemporary marketing tools and practices and the expectation that they will change both quantitatively and qualitatively as technology advances and tools are developed to better capture the behavioral aftermath of marketing investments. Current marketing systems and practices involve several items, including but not necessarily limited to, customer acquisition, customer retention, branding, insight, conversion, intellectual property, public relations, personnel recruitment, and international relationships.

A variety of approaches are available to effect customer acquisition for businesses. Representative tactics include: (1) affiliate and pay-per-performance business relationships; (2) referral (viral) marketing, i.e., mechanisms for turning current customers into advocates for your business as perhaps best exemplified by the footer you see attached to the bottom of every Email sent by a person with a hotmail Email account informing recipients that they can get free web-based Email at http://www.hotmail.com; (3) distribution practices; (4) search engine listing optimization; (5) various promotions; (6) e-mail advertising; (7) co-operative advertising; (8) on-line advertising, i.e., advertising agency review, direct media purchases, ad serving; (9) creative optimization; (10) return-on-investment and back-end metric analysis; and (11) guerrilla marketing, i.e., grass roots, non-media delivered advertising, i.e., stenciling your brand name on the sidewalk in chalk. It is understood that other customer acquisition tactics may be presently available or available in the future.

Customer retention is a common concern of many if not most businesses. Tactics employed for customer retention include but are not limited to the following or combinations thereof: (1) outbound Email programs; (2) loyalty programs; (3) various promotions; and (4) customer service enhancements, i.e., inbound Email management, Instant Messenger support, etc.

Branding is a process that occurs over time and is an important goal for businesses. Tactics employed to facilitate branding include but are not limited to brand auditing, positioning review, tracking studies, search engine buzz indices, brand management tools, and using advertising agencies. A brand audit should assess a client=s strengths and weaknesses, determine what the particular brand should mean and accomplish over time, and determine appropriate legal protection and modes of effective exploitation. Brand management tools include, for example, appropriate brand guideline materials and methods, appropriate color palettes and the like. The use and role or interactive advertising agencies should be determined.

Conversion is a situation where a business is able to attract people or users to their web site but has difficulty converting such web visitors to customers. Tactics employed to facilitate conversion include but are not necessarily limited to the following or combinations thereof: (1) personalization of content; (2) dynamic publishing; (3) collaborative filtering; (4) promotions or special offers; (5) targeting lead generation; (6) two-step conversion process; and (7) advertising agency review for site design. Personalization of content is based upon the particular profile of the user.

Insight involves a situation where a user or client expresses the need to be better informed about their customers, and/or their competition, and/or how a product or products is being utilized. Tactics or processes that may be employed individually, collectively, or in part or combination thereof include, but are not necessarily limited to: (1) market surveys; (2) customer focus groups; (3) click stream pathing and behavioral profiling; (4) user laboratories; (5) customer advisory board(s); (6) lifetime value analysis; (7) competitive tracking tools, i.e., expenditures, messaging, audience composition etc; (8) news clipping service(s); (9) competitive review process template.

The acquisition and maintenance of desirable public relations is an important part of an interactive marketing system. Accordingly, a client or user can facilitate appropriate press or media coverage by means of the following non-limitative procedures or tactics which may be employed individually, collectively, or in part thereof: (1) press kit design and content construction; (2) media outreach, i.e., identifying for the client or user who could or should be contacted, and procedures for such process; (3) public relations agency review; (4) speaking bureau(s); and (5) guerrilla publicity stunts.

A client or user may desire to develop international or non-United States segments of their customer base. This objective can be facilitated by use of the following non-limitative methods or tactics which may be used individually, collectively, or in part thereof: (1) ad-serving domain targeting; (2) dynamic, local language publishing; (3) international search engine registration and optimization; (4) identification and market assessment of foreign countries of market importance; and (5) review of international marketing vendors.

Intellectual property assets of the client business are enhanced and newly created during the development and implementation of an interactive marketing program. Sufficient modes of legal protection of these assets should be selected and effected continuously to maximize their business value. Traditional modes of legal protection of intellectual property include trademarks, copyrights, patents, and trade secrets. The success of an interactive marketing program may depend upon the implementation of intellectual property protection for their particular system or parts thereof. For example, branding often involves the successful use of trademarks or servicemarks.

The recruitment and retention of qualified staff, while not a marketing system in strict definition, is an important facet of an optimized marketing system. Implementation of a marketing system of the invention depends in significant part upon the client or user having access or such qualified personnel. Knowledge of what personnel will be required to implement an interactive marketing system can be provided to the client or user if desired. Recruiting includes the following non-limitative tactics or methods which may be used individually, collectively or in part thereof: (1) development of organizational charts and job descriptions; (2) identification or candidate requirements; and (3) providing leads to prospective candidates. Once qualified personnel are hired, appropriate training on the full use of the integrated marketing systems of the invention should be effected.

Once the client or user diagnosis stage and the interactive marketing materials and methods assessment stage of the invention have been completed, a customized interactive marketing system is constructed and recommended (FIG. 1, Step 4) using the criteria, tools, systems and processes herein described. Thereafter the client or user will implement and manage (FIG. 1, Step 5) the interactive marketing system. The systems implemented by the client or user should thereafter be monitored (FIG. 1, Step 6) using established metrics reflecting the marketing goals of the client or user.

The continuously interactive rapid response marketing systems of the invention comprise several components. In the event the business does not have marketing communications in place, marketing of any convenient type may be implemented by any convenient means know to the art. There is a means for selecting marketing communications activity. A means for collecting performance data of the selected marketing communications activity is present. Any of the wide variety of marketing communications may be utilized and data collected by any convenient means, including manual, visual, electronic, telephonic, or any electromagnetic-based monitoring means or the equivalent. Once the marketing communications data are collected, such is processed or organized. Such processing may be manual or use any conventional computer or other suitable reporting means. One or several databases may be maintained. A means is available for evaluating the processed performance data. Preferably, the processed performance data of all marketing communications activity or investments are evaluated relative to the performance of the expected contribution of marketing communications to the business objectives or goals of the marketer or business enterprise. In the system of the invention, there is a means for reacting to the evaluation by modifying, if necessary, marketing communications activity. Marketing activity for any given communication may be increased, decreased, canceled or left unchanged. New modes of marketing communications may be implemented at any suitable time.

Marketing communications activity may involve printed or electronic media or any combination thereof. Historical marketing performance data, if available, may be used for comparison purposes. Data from industry norms may also be used. Data sources may comprise media contracts, media delivery information, survey information, call center volume, store foot traffic, sales scanner data, focus group responses or web site traffic or combination thereof. Marketing system data may most conveniently be maintained in a centralized database. However, multiple databases or combination databases may be used. The systems of the invention provide individualized marketing programs of high efficiency. The effectiveness of marketing communications is measured, evaluated and reacted to on an ongoing basis. This is in contrast to the time required to wait for a marketing campaign to be completed over a fixed term or to be measured at pre-determined spaced time intervals. Optimal use of financial resources available for marketing may be obtained by the systems of the invention with continuous interactivity. The marketing systems herein described are interactive, capable of rapid evaluation and reaction to such evaluation, are of high efficiency, are cyclic in nature, and readily amenable to monitoring of results on an ongoing basis. With communications ever so frequently moving at the speed of light, marketing systems must acclimate in order to best serve contemporary business interests.

What is claimed is:

1. A continuously interactive rapid response marketing system for business enterprise comprising:
(a) means for selecting marketing communications activity;
(b) means for collecting performance data of said selected marketing communications activity;
(c) means for processing said marketing communications activity performance data;
(d) means for evaluating said processed performance data of all marketing communications activity; and
(e) means for reacting to said evaluation by modifying if necessary marketing communications activity.

2. A marketing system according to claim 1 wherein evaluating said processed performance data of marketing communications activity comprises evaluation relative to the expected contribution of marketing communications to the business objectives of said business enterprise.

3. A marketing system according to claim 1 wherein said marketing communications activity comprises functions and associated financial costs thereof comprising printed or electromagnetic-based media.

4. A marketing system according to claim 1 wherein said processing of marketing communications activity data further comprises historical performance data.

5. A marketing system according to claim 3 wherein said media comprises the Internet.

6. A marketing system according to claim 1 wherein said marketing communications activity data is collected by manual, electronic or telephonic monitoring means.

7. A marketing system according to claim 1 wherein said data processing integrates varied data sources and comprises a reporting interface means.

8. A marketing system according to claim 7 wherein said data sources comprise media contracts, media delivery information, survey information, call center volume, store foot traffic, sales scanner data, focus group responses or web site traffic or combination thereof.

9. A marketing system according to claim 7 wherein said data is maintained in a centralized database, multiple databases, or combination thereof.

10. A marketing system according to claim 1 wherein said business objectives comprise customer acquisition, customer retention, branding, intellectual property acquisition, conversion, insight, development of international business relationships or customer bases, increased revenues, diversification of products or services, increased profits, personnel recruitment, or public relations or combination thereof.

11. A marketing system according to claim 1 wherein said rapid response marketing system is maintained on an ongoing basis.

12. A marketing system according to claim 1 wherein said reacting to said evaluation of marketing communications activity involves no modification, or modification of marketing activity by increasing or decreasing some or all of marketing communications activities, deleting selected activities, adding new marketing activities, or altering the messaging of selected marketing communications activity.

13. A method for construction of individualized performance based continuously interactive marketing systems for business enterprises comprising:
(a) identifying the expected contribution of marketing communications to the business objectives of said business enterprise;
(b) identifying performance metrics of said marketing communications comprising a performance model or standards to measure accomplishment of said business objectives;
(c) identifying industry marketing communications information, past and current marketing communications activities and history thereof, if any, of said business enterprise;
(d) identifying available interactive marketing tools;
(e) selecting a marketing communication strategy comprising selecting marketing tools of the business enterprise or available interactive marketing tools sufficient to accomplish the expected contribution of marketing communications to the business objectives of said business enterprise;
(f) selecting a means for monitoring said marketing tools on an ongoing basis;
(g) selecting a means for evaluating on an ongoing basis the identified performance metrics;
(h) selecting a means for reacting to said evaluation of said marketing communications performance metrics;
(i) implementing said continuously interactive marketing system.

14. A method for the construction of individualized performance based continuously interactive marketing systems for business enterprises comprising:
(a) selecting marketing communications activity;
(b) collecting performance data of said selected marketing communications activity;
(c) processing said marketing communications activity performance activity;
(d) evaluating said processed performance data of all marketing communications activity;
(e) reacting to said evaluation by modifying if necessary marketing communications activity.

15. A method according to claim 14 wherein said evaluating of said performance data of marketing communications activity comprises evaluating relative to the expected contribution of marketing communications to the business objectives of said business enterprise.

16. A method for optimizing marketing communications activity which comprises using a continuously interactive rapid response marketing system.

17. A method according to claim 16 wherein said marketing system comprises:
(a) means for selecting marketing communications activity;
(b) means for collecting performance data of said selected marketing communications activity;
(c) means for processing said marketing communications activity performance data;
(d) means for evaluating said processed performance data of all marketing communications activity;
(e) means for reacting to said evaluation by modifying, if necessary, marketing communications activity.

18. A method according to claim 17 wherein evaluating said processed performance data of marketing communications activity comprises evaluation relative to the expected contribution of marketing communications to the business objectives of said business enterprise.
